(19) United States
(12) Patent Application Publication
(10) Pub. No.: US 2001/0023194 A1
(43) Pub. Date: Sep. 20, 2001

(54) Portable communication apparatus having a liquid crystal display and a method for the operation thereof

(76) Inventors: Mats Pettersson, Lund (SE); Erik Heded, Lund (SE)

Correspondence Address: Stanley R. Moore, Esq., JENKENS & GILCHRIST, P.C., 1445 Ross Avenue, Suite 3200, Dallas, TX, 75202-2799, US

(21) Appl. No.: 09/810,744

(22) Filed: Mar. 16, 2001

(30) Foreign Application Priority Data
Mar. 20, 2000 (SE) 0000906-8

(51) Int. Cl. H04B 1/38

(52) U.S. Cl. 455/566; 455/90; 345/49; 345/52; 345/56; 455/550

(57) ABSTRACT

A portable communication apparatus (1) has a movable cover (16) with a liquid crystal display (19, 20) mounted thereon. The liquid crystal display (19, 20) is double-sided in at least one part (20), hence showing the information both from a front side and from a back side (21). This part of the display (20) is transmissive, and the rest of the display (19) is either reflective or transflective. The information is viewable through a window (22) in the cover (16) when the cover (16) is closed. As soon as the cover (16) changes positions from closed to opened, or from opened to closed, the information will be rotated 180°, so that the information will appear correctly. The portable communication apparatus has means (30, 31) and steps for the rotation of information, which automatically will be initiated, when the position of the cover (16) is detected by a controller (30).

### TECHNICAL FIELD

The present invention relates to a portable communication apparatus comprising a main body and a cover having a liquid crystal display mounted thereon, the cover being movably attached to the main body.

The invention also relates to a liquid crystal display to be attached to a portable communication apparatus.

In addition the invention relates to a cover to be movably attached to a portable communication apparatus.

The invention further relates to a method of operating a portable communication apparatus comprising a cover and a liquid crystal display for showing information.

### PRIOR ART

Examples of portable communication apparatus as set out above are for instance mobile telephones, portable digital assistants (PDA), palmtop computers etc.

For the rest of this document, reference is made to a mobile telephone, which is chosen to represent a portable communication apparatus according to the invention. However, the invention shall in no way be limited to merely a mobile telephone.

In existing, portable applications using a liquid crystal display (LCD) a transflective LCD is most frequently utilised. A transflective LCD is both reflective and transmissive. Information is made visible on a reflective display by the ambient light, or if this is not sufficient, by frontlighting, and on a transmissive display by backlighting. A transflective display is made to be used with backlighting, but it is also usable if the ambient light is sufficient. It is not possible to view data from the rear side of a transflective LCD, only from the front side, since a reflective layer is provided behind the display to form a background for the reflective mode. To show information on both a rear side and a front side requires a transmissive LCD, which must be illuminated from the back for visibility. However, a great problem is that a transmissive LCD without a specific background will appear like a greyish window, and there will be a very high risk that the information on the display will be almost unreadable. Existing transmissive LCD displays, including colour displays, have been mainly used in applications such as portable computers (laptops) and PDA's.

Users of mobile telephones desire small, handy telephones with a sufficient capacity of software and memory, but in addition they want a large display and mostly also a keyboard. These demands are contradictory. One solution to achieve a larger display is to replace the keyboard with a larger touchscreen on top of a display. A serious drawback in this case is however that a slight distortion will arise, and therefore the performance of the display will degrade, the contrast will go down and the backlight through the entire LCD-touchscreen package will be dimmer. Another disadvantage is the lack of a keyboard, which many people are used to, and a solution with a keyboard would be preferable.

Another solution to get a larger display area is to mount a display on the inside of the cover of the telephone; however, a serious drawback in this case is that important standby information is hidden when the cover is closed.

### SUMMARY OF THE INVENTION

An object of the present invention is to remedy the drawbacks above and to provide a handy, full performance mobile telephone having a large liquid crystal display, which is mounted on and protected by the cover of the telephone, and which continuously shows valuable standby information without intruding on the effective display area. For attaining the above objects a partly double-sided liquid crystal display is mounted on the cover, the information being visible both on a front side of the display and on a back side of the display through a window in the cover when this is closed.

Another object of the invention is to provide a method of operating a mobile telephone comprising a cover and a partly double-sided liquid crystal display mounted thereon for showing information correctly. For attaining this object, a method for detecting the position of the cover and for rotating the information to ensure that the information not will be read up side down when the cover changes positions is provided in the telephone.

Other purposes, features and advantages of the present invention will appear from the following detailed description, from the attached drawings as well as from the dependent claims.

### BRIEF DESCRIPTION OF THE DRAWINGS

A preferred embodiment of the invention will be described in more detail below, reference being made to the accompanying drawings, in which

FIG. 1 is a schematic front view of a portable communication apparatus according to the invention, exemplified as a mobile telephone, having a double-sided liquid crystal display mounted on the cover, the cover being in an opened position,

FIG. 2 is a schematic front view of the mobile telephone shown in FIG. 1, the cover however being in a closed position,

FIG. 3 is a schematic block diagram of the main functional parts of the apparatus shown in FIG. 1 and FIG. 2,

FIG. 4 is a schematic side view of the liquid crystal display mounted on the cover according to the invention, and

FIG. 5 is a flow chart illustrating a method of operating the portable communication apparatus for correctly showing information on the liquid crystal display according to the invention.

### DETAILED DISCLOSURE OF A PREFERRED EMBODIMENT

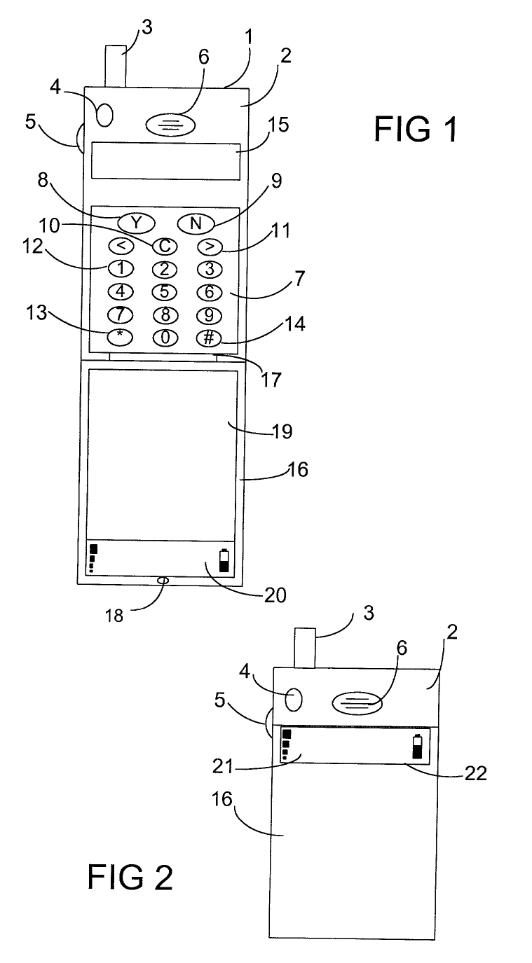

A portable communication apparatus is shown in FIG. 1 and is here exemplified as a mobile telephone 1. The telephone 1 has a main body or housing 2, an antenna 3 mounted on the top of the housing, a status indicator 4, a volume adjustment control 5, a speaker 6 and a keypad 7. The keypad has a plurality of individually keys, such as a YES button 8 (Y), a NO button 9 (N), a clear button 10 (C), arrow buttons 11 and numeric buttons 12 (labelled “1”, through “9”), a star button 13 and a hash button 14. On the upper part of the housing a reflective area 15 is provided, which will be disclosed further below.

A foldable cover 16 is swingably mounted to the housing 2 of the apparatus 1 by means of a hinge mechanism 17, and the lower part of the cover 16 is provided with a microphone 18. A liquid crystal display (LCD) comprising two parts, LCD1 19 and LCD2 20, is mounted on an inner side of the cover 16. The LCD2 20 is double-sided, which means that information is viewable on a front side of the LCD2 20 when the cover 16 is opened, but also on a back side 21 of the LCD2 20 through a window 22 in the cover 16 when this is closed, as illustrated in FIG. 1 and FIG. 2.

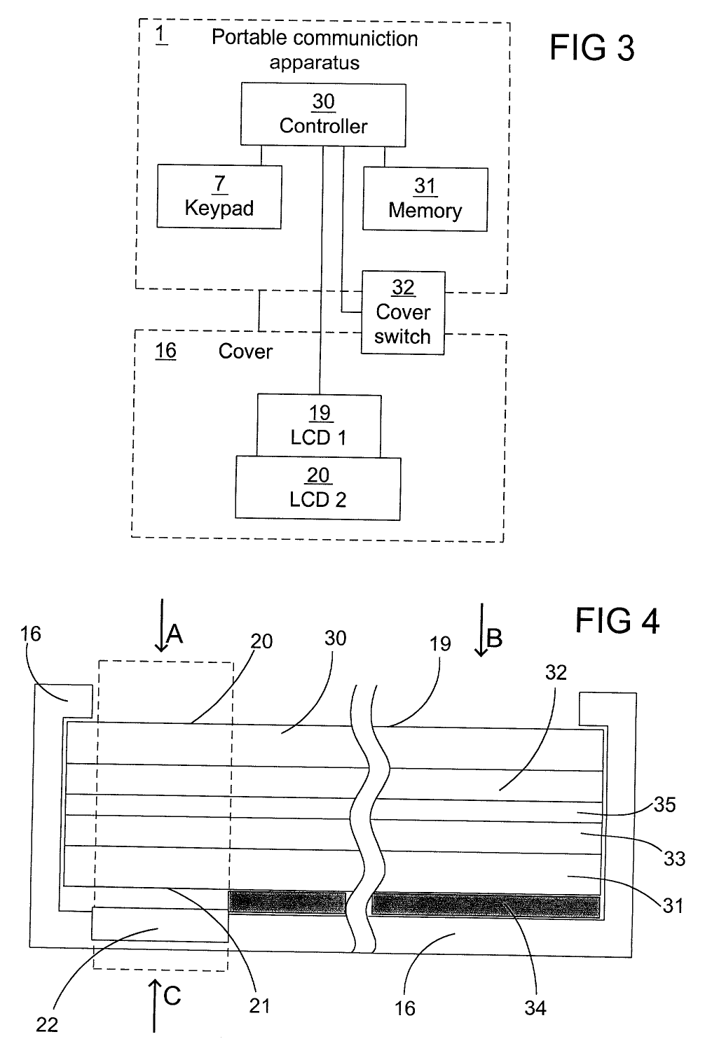

The basic components of the mobile telephone 1, within the context of the present invention, are shown in FIG. 3. A controller 30 is operatively connected to an electronic memory 31 as well as to the display parts 19, 20 and the keypad 7. The controller 30 may be generally known per se and is typically implemented by a microprocessor or another logical device. Likewise, any commercially available components, such as RAM memory circuits, EPROM circuits, etc may implement the memory 31. A cover switch 32 is operatively connected to the controller 30. The switch 32 detects the position of the cover 16. Alternatively it may detect when the cover 16 changes position from opened to closed and vice versa. This task is essential to ensure that the information is not read upside down, since the information on the LCD2 has to be rotated 180° around an axis, which is parallel to a rotation axis of the cover 16, when the cover 16 changes position from closed to opened and vice versa. A method for achieving the above will be described in further detail below with reference to FIG. 5.

From the disclosure above, it is obvious that the mobile telephone 1 has a novel feature in comparison with an arbitrary telephone regarding the liquid crystal display with its two parts LCD1 19 and LCD2 20, which now will be described in more detail.

A general liquid crystal display comprises two glass substrates with liquid crystals provided between them, and two polarizers. By adding a reflective or a transflective layer or simply by omitting any such layer it is possible to get a LCD with different properties regarding information visibility under different light conditions. The information on a reflective display is seen by ambient light, or if this is not sufficient by frontlighting, on a transmissive one by backlighting and consequently the information on a transflective display is visible by either ambient light on the front or by illuminating from the back. The use of an arbitrary LCD in a mobile telephone or in another electronic apparatus is well known per se. To combine a transmissive LCD and a transflective LCD to form a unity in a single liquid crystal display according to the invention is a novelty.

According to the preferred embodiment, the telephone 1 has a two-part liquid crystal display, LCD1 19 and LCD2 20, which is mounted on the cover 16 of the apparatus 1. When the cover 16 is closed, the total display is facing the keypad 7, and the back side 21 of the LCD2 20 is seen through the window 22 of the cover 16, as illustrated in FIG. 2. The two parts of the display, LCD1 19 and LCD2 20 respectively, differ slightly in construction, resulting in that the visibility of information depends on the lighting of the display.

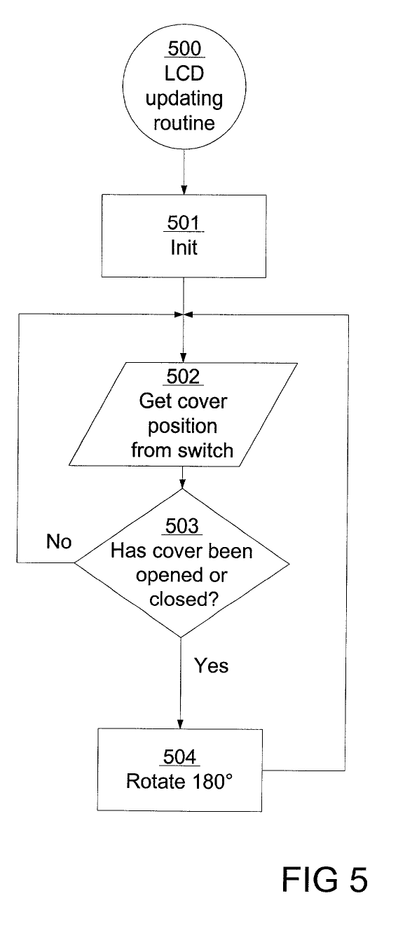

The basic construction of the LCD according to the invention is shown in FIG. 4. As mentioned above, two glass substrates 32, 33 with liquid crystals 35 between them are provided as well as two polarizers 30, 31. A transflective layer 34 is added to one part of the display, thereby making this part, the LCD1 19, transflective. The information being shown on the LCD1 19 is viewable when the cover 16 is opened and the display is illuminated by ambient light or by backlighting, as illustrated by the arrow B in FIG. 4.

The part of the display without any added layer, the LCD2 20, is transmissive. As schematically illustrated in FIG. 4, data is thus viewable on the front side when the cover 16 is opened (arrow A), and on the back side 21 through the window 22 when the cover 16 is closed (arrow C).

The housing 2 of the apparatus 1 is provided with an area 15, which is in register with the window 22, to make the transmissive part of the LCD readable, when the cover 16 is closed. The area 15 is either reflective or transflective, and in this case it must be illuminated from the back for making the information visible. Preferably standby information, e g time, battery capacity etc, is exposed on the transmissive LCD2 20 to facilitate for the user to get this type of information fast and easy. Various materials can be used to form the area 15, e g an electro-luminescent film (EL-film), a mirror, a diffuse mirror, a reflective hologram, a bright metallic colour, and the chosen material may be utilised to personalise the telephone 1. The area material can either be moulded into the front of the telephone 1 or printed or glued onto the front.

When the cover 16 is opened, the entire display comprising the transflective LCD1 19 and the transmissive LCD2 20 is visible. The transmissive LCD2 is still showing the standby information, which is rotated 180° around an axis parallel to a rotation axis of the cover 16 for a correct presentation, and the transflective LCD1 19 will be available for any other information.

In an alternate embodiment the cover 16 can be attached to the top of the apparatus 1, and hence the keypad 7 will be located below the LCD. A further alternate embodiment arises when the cover 16 is attached to one of the longitudinal sides of the apparatus 1, the keypad 7 being beside the LCD either to the left or to the right.

Other alternate embodiments will be provided if the transmissive part of the display, the LCD2 20, and the window 22 is positioned anywhere on the cover 16, but a location at one of the sides (top, bottom, left or right) is preferable.

In an alternate embodiment the LCD1 (19) may be transmissive, and in this case backlighting is provided in the cover 16 to make the information visible.

Yet another embodiment will be provided if the display comprises two separate displays, e g one transmissive and one transflective, but the preferred embodiment is the one which has only one display including the two parts 19, 20 with different features, as described above.

The cover 16 is preferably a flip.

A flow chart in FIG. 5 illustrates a method of operating the mobile telephone 1 for correctly showing the information on the LCD comprising the transflective part 19 (LCD1) and the transmissive part 20 (LCD2). It is assumed that it is well known for the skilled man that software routines are stored in the telephone. The controller 30 of the telephone 1 is provided with a LCD updating routine 500, which is initialised in a step 501. In a step 502 the cover switch 32 detects the position of the cover 16, ie whether it is opened or closed, or alternatively when the cover 16 changes position. In a next step 503 the routine 500 checks whether the cover 16 has changed positions. If the answer is in the affirmative, the information on the transmissive LCD2 20 will be rotated 180° in a step 504; otherwise the control will be transferred back to step 502. To rotate the information is necessary for avoiding it to be read upside down when the cover 16 has changed position. When the step 504 is reached and the information has been rotated 180°, the control will be transferred to step 502, hence forming an endless loop, thereby eliminating the risk for showing the information upside down.

It should be understood that the mobile telephone 1 described above only is an example, and that the liquid crystal display comprising the two parts 19, 20 could be utilised in any type of a portable communication apparatus.

1. A portable communication apparatus (1) comprising a main body (2) and a cover (16) having a liquid crystal display (19, 20) mounted thereon, the cover being movably attached to the main body (2), characterized in
that at least one part of the liquid crystal display (19, 20) is double-sided, the information on the at least one part of the display (19, 20) being viewable from a front side (20) when the cover (16) is in an opened position and through a window (22) in the cover (16) from a back side (21) of the display (19, 20) when the cover (16) is in a closed position,
that the window (22) is in register with an area (15) in the main body (2) when the cover (16) is in the closed position, the area (15) having optical features suitable for enhancing the visibility of the information on the at least one part of the liquid crystal display (19, 20) when viewing through the window (22), and
that the at least one part of the liquid crystal display (19, 20) is transmissive.

2. A portable communication apparatus (1) according to claim 1, characterized in that the liquid crystal display (19, 20) has a second part, different from the at least one part, said second part being either reflective or transflective.

3. A portable communication apparatus (1) according to claim 2, characterized in that the second part of the liquid crystal display (19, 20) is only viewable from the front side of the display (19, 20) when the cover (16) is in the opened position.

4. A portable communication apparatus (1) according to claim 1, 2 or 3, characterized in that the front side of the liquid crystal display (19, 20) is facing the main body (2) of the communication apparatus (1), when the cover (16) is closed.

5. A portable communication apparatus (1) according to claims 1-4, characterized in that the area (15) is illuminated from the back.

6. A portable communication apparatus (1) according to claims 1-4, characterized in that the area (15) is reflective.

7. A portable communication apparatus (1) according to claims 1-4, characterized in that the area (15) is transflective.

8. A portable communication apparatus (1) according to claims 1-4, characterized in that the area is electroluminescent and provides backlighting to the at least one part of the liquid crystal display (19, 20).

9. A portable communication apparatus (1) according to any preceding claim, characterized in that information on the at least one part of the liquid crystal display (19, 20) is rotated 180° around an axis, which is parallel to a rotation axis of the cover (16), when the cover (16) changes positions from closed to opened or from opened to closed.

10. A portable communication apparatus (1) according to any preceding claim, characterized in that the movable cover (16) is a flip.

11. A portable communication apparatus (1) according to any preceding claim, characterized in that the main body (2) of the communication apparatus (1) comprises a keyboard (7).

12. A liquid crystal display (19, 20) to be attached to a portable communication apparatus (1), characterized in
that at least one part of the liquid crystal display (19, 20) is double-sided, the information on the at least one part of the display (19, 20) being viewable from a front side (20) of the liquid crystal display (19, 20) and from a back side (21) of the liquid crystal display (19, 20),
that the at least one part of the liquid crystal display (19, 20) is transmissive.
that a second part of the liquid crystal display (19, 20) is provided, different from the at least one part, said second part being either reflective or transflective.

13. A liquid crystal display (19, 20) according to claim 12, characterized in that the another part of the liquid crystal display (19, 20) is only viewable from the front side of the display (19, 20).

14. A cover (16) to be movably attached to a portable communication apparatus (1), characterized in that a liquid crystal display (19, 20) is mounted on the cover (16), the liquid crystal display (19, 20) being double-sided in at least one part thereof, hence showing information from both a front side and a back side (21) of the liquid crystal display (19, 20).

15. A cover (16) according to claim 14, characterized in that the part of the liquid crystal display (20), which is viewable from both the front side and the back side (21), is transmissive.

16. A cover (16) according to claim 15, characterized in that a window (22) is provided in the cover (16), the double-sided part of the liquid crystal display (19, 20) being viewable in the window (22).

17. A method of operating a portable communication apparatus (1) comprising a cover (16) and a liquid crystal display (19, 20) for showing information, characterized by the steps of:
providing the liquid crystal display (19, 20) on the cover (16), so that the liquid crystal display (19, 20) is viewable both from a front side and from a back side (21),
detecting when the cover (16) is opened or closed, and
rotating the information 180° in response thereof.
